(19) United States
(12) Patent Application Publication
(10) Pub. No.: US 2026/0251401 A1
(43) Pub. Date: Aug. 27, 2026

(54) THERMOCHEMICAL ENERGY STORAGE SYSTEM USING EARTH-ABUNDANT MATERIALS TRIGGERED BY ADDITION OF WATER AND METHOD THEREFOR

(71) Applicant: Earthermic Technologies, Inc., Vancouver (CA)

(72) Inventors: Brooks Bergreen, Vancouver (CA); Braeden Dessert, Saskatoon (CA); Stephen Foley, Saskatoon (CA); Lan Huang, Saskatoon (CA); Mario Proulx, Saskatoon (CA)

(21) Appl. No.: 19/489,728

(22) PCT Filed: Jun. 3, 2024
(86) PCT No.: PCT/CA2024/050744

§ 371 Date: Dec. 3, 2025

Related U.S. Application Data
(60) Provisional application No. 63/471,074, filed on Jun. 5, 2023.

(51) Int. Cl. F28D 20/00; C09K 5/18

(52) U.S. Cl. CPC F28D 20/003; C09K 5/18

(57) ABSTRACT

A system for thermochemical energy storage using earth-abundant materials triggered by the addition of water is provided. The system comprises reactants including CaO, P2O5, Fe, and KNO₃ among others in a matrix. Exothermic reaction is initiated by addition of water. Thermal generation over time may be adjusted by selection of matrix and by selective addition of additional reactants such as alternative oxidants or secondary fuel sources.

### FIELD

Certain aspects of the present disclosure generally relate to energy storage and generation, specifically, energy storage and generation using earth-abundant materials.

### BACKGROUND

Sustainable energy is becoming increasingly popular as the effects of anthropogenic climate change are incrementally felt throughout the world. Much focus has been placed into the research and development of renewable energy resources, but many of these sources, such as wind or solar power face issues where peak generation is rarely aligned with peak demand, requiring significant energy storage capacity, making these sources unsuitable for base load generation without expensive energy storage facilities. Typical peaking power generation sources rely on fossil fuels, which are non-renewable and have a high carbon footprint, or have strict geographic requirements, such as hydroelectric power, have other negative environmental impacts, or rely on battery storage which requires rare materials. Accordingly, it is desired to have scalable carbon-neutral thermochemical energy storage systems using common, earth-abundant materials. The heat generated from such systems could be used to power arbitrary thermoelectric devices; for cooking, remote area backup power, or waste processing and incineration; or in systems where sparking or emissions are of concern.

### SUMMARY

Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims.

One aspect of the present disclosure provides a thermochemical energy storage system using a combination of common minerals and salts which are obtained in multi-tonne quantities as products or byproducts from mining or common industrial processes. Addition of water to these earth-abundant materials results in a sustained and controllable release of thermal energy. The individual components are readily available and indefinitely stable in an anhydrous environment under otherwise ambient conditions until the addition of water, making the components safe to store and use and easy to handle. Addition of water initiates a flameless, sparkless, exothermic reaction. CO₂ levels above ambient concentrations were not detected in analyses of atmosphere immediately above the solid materials during the exothermic reactions. The system may be suitable for applications in waste decomposition and sequestration, heating, and peak load electricity generation, for example.

Once the exothermic reaction is initiated, various commercially available thermal energy capture and conversion systems can be used to harness the energy for use, such as steam turbines or other thermally-driven electrical generators, for example. The specific thermal energy capture systems would vary depending on scale and application.

### BRIEF DESCRIPTION OF THE DRAWINGS

FIG. 1 is a graph showing temperature over time of different embodiments of a thermochemical energy storage system with varying water stoichiometry and addition of oxidants and a secondary fuel source.

FIG. 2 is a graph showing temperature over time of different embodiments of the thermochemical energy storage system with different reaction masses.

FIG. 3 is a graph showing temperature over time of different embodiments of the thermochemical energy storage system with differing amounts of water addition.

FIG. 4 is a graph showing temperature over time comparing different embodiments of the thermochemical energy storage system, having different materials in each respective matrix.

FIG. 5 is a graph showing temperature over time comparing different embodiments of the thermochemical energy storage system, having different carbon-based materials in each respective matrix.

FIG. 6 is a graph showing temperature over time comparing different embodiments of the thermochemical energy storage system, wherein the matrix comprises a starch.

### DETAILED DESCRIPTION

Various aspects of the novel systems, apparatuses, and methods are described more fully hereinafter with reference to the accompanying drawings. The disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented, or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. Any aspect disclosed herein can be embodied by one or more elements of a claim.

Although aspects are described herein, many variations and permutations of these aspects fall within the scope of the disclosure. Although some benefits and advantages of the preferred aspects are mentioned, the scope of the disclosure is not intended to be limited to benefits, uses, or objectives. The detailed description and drawings are merely illustrative of the disclosure rather than limiting.

In accordance with one disclosed aspect, a thermochemical energy storage system comprises reactants and a matrix. Upon addition of water, the reactants and the matrix undergo a sustained exothermic reaction, such that the energy stored in the reactants and matrix are released to generate thermal output. The thermal output produced by the exothermic reaction is dependent and adjustable according to the quantity and nature of the reactants, the matrix, and the amount of water added. The matrix acts as an insulator and thermal sink, which controls reaction rate and regulates thermal output of the system. By varying the selection of the matrix, various thermal generation profiles can be achieved.

Thermal energy production is based on a laddering approach where a primary exothermic event of a first reactant is initiated by addition of a water source which in turn initiates a secondary exothermic event of a second reactant at a higher temperature than the first, due to a higher activation temperature of the second reactant compared to the activation temperature of the first reactant. In embodiments, subsequent exothermic events of subsequent reactants are also possible, where the activation temperatures of the subsequent reactants are higher than the activation temperatures of the second reactant and progressively higher than each subsequent reactant, the subsequent exothermic events being in turn initiated by the secondary exothermic event achieving even higher temperatures. In an embodiment, a primary exothermic event is generated by a reaction of CaO with P₂O₅ in the presence of water to form various calcium phosphates. In some embodiments, a secondary exothermic event is generated by the addition of the oxidant. In yet other embodiments, a tertiary exothermic event is generated by the addition of the secondary fuel source to augment thermal generation. In some embodiments, the secondary fuel sources initiated by the CaO/P₂O₅ reaction may comprise naturally occurring organic or hydrocarbon feedstocks. Test results have demonstrated that peak temperatures of over 600° C. can be reached and sustained for over several minutes with sustained elevated temperatures for over 30 minutes with as little as 20 g total of material. Scaling of the system increases both energy generation time as well as peak temperature. In some embodiments, fourth and fifth exothermic events are generated by the addition of further reactants and feedstocks that can product exothermic reactions, having fourth and fifth activation temperatures, respectively, including but not limited to, for example, salts and metals.

In one embodiment, the reactants comprise CaO, P₂O₅, KNO₃, or Fe. In other embodiments, the reactants comprise an additional or alternative oxidant, such as KMnO₄, Na₂[B₂O₄(OH)₄], or H₂O₂, KClO₄, KClO₃. In yet other embodiments, the reactants further comprise a secondary fuel source such as coal, hydrocarbons such as paraffin wax, soy wax, or carbohydrates such as sucrose, dextrose, sorbitol, or starch. In yet further embodiments, the reactants additionally comprise NaCl, NaOH, oxalic acid, sodium citrate, citric acid, Al₂O₃, Al, CaCl₂, Fe₂O₃, or CaCO₃.

In one embodiment, the matrix comprises kaolinite, bentonite, sand, activated carbon, calcium phosphate (product from spent reactions), or can include the secondary fuel sources also acting as the matrix including coal, hydrocarbons such as paraffin wax, soy wax, or carbohydrates such as sucrose, dextrose, sorbitol, and starch.

In some embodiments, water added to the system does not have to be pure in nature and can be wastewater from many sources without significant affect to the thermal generation. For example, in one exemplary embodiment, the water may contain sediment, which adds to the composition of the matrix of the system. In other embodiments, the water may comprise water additives such as NaCl and hydrogen peroxide.

In yet further embodiments, the water may be water naturally present in hygroscopic materials which may be used as part of the reactants or the matrix. In such embodiments, water is not added as an independent reagent. The water may be naturally trapped in a solid which can function as additive or the matrix; in such embodiments, the solid serves as the water source, and an exothermic reaction is initiated upon addition of the water-containing solid. In yet further embodiments, non-volatile sources of water, such as CaSO₄·½H₂O, SnCl₂·2 H₂O, FeCl₃·6 H₂O, or other hydrates, for example, can be used to initiate the thermochemical reactions. Such non-volatile sources of water may have beneficial applications for operation of the system in a wider range of conditions, including vacuum conditions.

In accordance with one disclosed aspect, the system comprises between 10% and 50% CaO by mass, preferably between 15% and 35%; between 10% and 55% P₂O₅ by mass, preferably between 20% and 30%; between 2% and 10% Fe by mass, preferably between 3% and 5%; and between 5% and 40% KNO₃ by mass, preferably between 7% and 20%. The matrix is between 15% and 35% of the system by mass, and preferably between 20% and 25%. Added water is between 2% and 25% of the system by mass, and preferably between 5% and 12%. Finally, the system comprises between 5% and 25% additional additives by mass, and preferably between 7% and 15%.

In one exemplary embodiment, it is desirable to achieve a peak temperature sufficient to initiate tertiary exothermic events by initiating self-sustaining exothermic reactions in the secondary fuel source. Material for the matrix is selected, such as a carbon-containing secondary fuel source like bituminous coal, which results in a sufficiently high peak temperature of over 400° C. to initiate the tertiary fuel source. Sustained energy generation can then be achieved through the tertiary exothermic reaction. Such a thermochemical energy storage system is a result of a series of non-combustion processes which generates energy in a flameless, sparkless manner. The oxidant present in the system also allows the initiation of the secondary fuel to take place in oxygen-free conditions. These properties allow the system to be used for energy generation in conditions typically unsuitable for traditional fuels, such as in conditions which are flame, spark, or oxygen-sensitive, for example.

In yet another exemplary embodiment, it is desirable to achieve zero-carbon sustained energy generation over multiple minutes, with a lower peak temperature of about 150° C. to 200° C. An inert material may be selected for the matrix to avoid tertiary reactions which release CO₂, such as CaSO₄, silicon oxide, sand, or zeolites, for example. Additionally, carbon capture technology can be incorporated into the system, such as part of the matrix, to eliminate volatile carbon emissions. In one exemplary embodiment, commercially available additives, such as amines, may be added to the matrix. Amines react with CO and CO₂ which may be produced by secondary or tertiary reactions, and trap the carbon as a solid within the post-reaction residue. Alternatively, the system can also operate under anoxic conditions, such as under vacuum, which would also eliminate volatile carbon emissions.

The primary byproducts, such as calcium phosphates, are an industrially useful material in the production of fertilizers, and may be recovered from the system for further use, thereby reducing waste.

### Experimental Procedure

Powdered CaO, finely divided Fe filings, powdered KNO₃, and a matrix were added to a reaction vessel. Other reactants were then added per experimental parameters. Powdered P₂O₅ was added, and the mixture was stirred until homogeneous. Water was then added, and the mixture was immediately stirred for 5 to 15 seconds. Temperature was monitored and measured via a digital probe. Alternatively, water may be added dropwise to the system with no mixing, resulting in lower peak temperature, but sustained for longer durations.

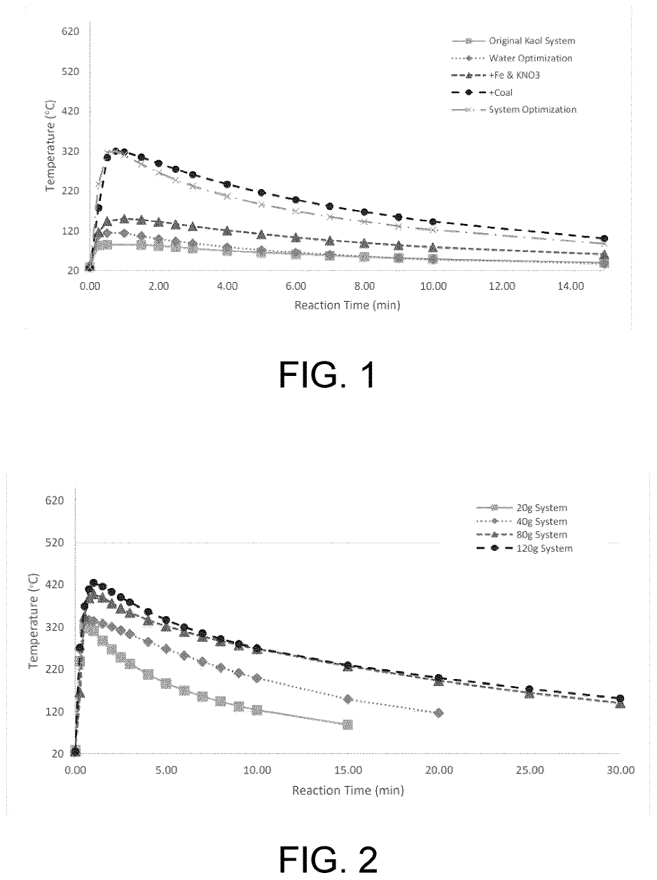

The process was then repeated with varying amounts of reactants, oxidant, matrix composition, and water, according to the exemplary formulations below, and the temperatures of the systems were measured and plotted to produce the graphs of FIGS. 1 through 6.

### Exemplary Formulations

Formulation to reach 450° C. CaO (4 g), Fe filings (0.83 g), KNO₃ (2 g), coal (2 g), and P₂O₅ (5 g) were combined. Starch (5 g) was added, and the mixture was stirred until homogeneous.

Formulation to reach 420° C. CaO (4 g), Fe filings (0.83 g), KNO₃ (4 g), and starch (5 g) as matrix (dried) were combined. P₂O₅ (5 g) was added, and the mixture was stirred until homogeneous. Water (2 ml) was added, and the mixture was briefly stirred.

Alternate formulation to reach 420° C. CaO (8 g), Fe filings (1.66 g), KNO₃ (8 g), and coal (10 g) as matrix were combined. P₂O₅ (10 g) was added, and the mixture was stirred until homogeneous. Water (4 ml) was added, and the mixture was briefly stirred.

Formulation to reach 320° C. CaO (4 g), Fe filings (0.83 g), KNO₃ (4 g), and coal (5 g) as matrix were combined. P₂O₅ (5 g) was added, and the mixture was stirred until homogeneous. Water (2 ml) was added, and the mixture was briefly stirred.

Formulation to reach 180° C. CaO (4 g), Fe filings (0.83 g), KNO₃ (4 g), and dextrose (5 g) as matrix were combined. P₂O₅ (5 g) was added, and the mixture was stirred until homogeneous. Water (2 ml) was added, and the mixture was briefly stirred.

Formulation to reach 380° C. CaO (4 g), Fe filings (0.83 g), KNO₃ (4 g), and activated carbon (5 g) as matrix were combined. P₂O₅ (5 g) was added, and the mixture was stirred until homogeneous. Water (2 ml) was added, and the mixture was briefly stirred.

Formulation to reach 620° C. CaO (8 g), Fe filings (1.66 g), KNO₃ (4 g), and P₂O₅ (10 g) were stirred until homogenous in reaction vessel. Starch (10 g) was added and the mixture was briefly stirred, yielding the profile seen in FIG. 6.

### Experimental Results

As shown in FIG. 1, variation of water stoichiometry and addition of additives such as Fe, KNO₃, and coal, all in a kaolinite matrix can be used to adjust energy production of a thermochemical energy storage system. The additional quantities of reactants, such as Fe and KNO₃, results in an increase of energy generation through secondary exothermic events. The addition of secondary fuel sources, such as coal, results in further increase of energy generation through tertiary exothermic events. Varying the stoichiometric ratio of Fe also modifies the heating profile.

As shown in FIG. 2, the thermochemical energy storage system is scalable based on system mass, as observed in a system comprising CaO, P₂O₅, KNO₃, and stoichiometric amount of Fe as reactants with coal as a secondary fuel source in a kaolinite matrix. An increase in system mass results in a corresponding increase of peak temperature as well as sustained energy generation over time.

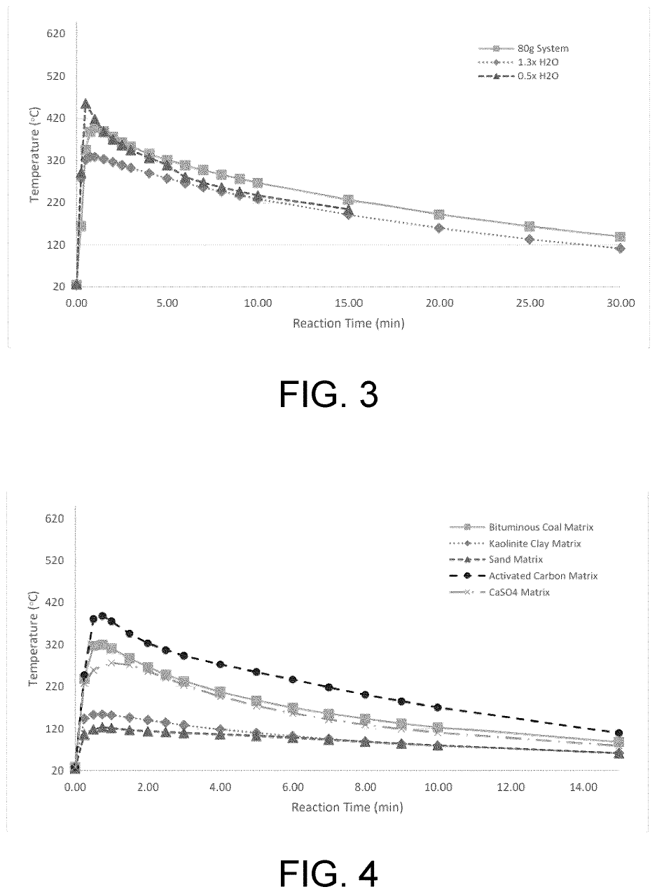

As shown in FIG. 3, thermal output of the thermochemical energy storage system is dependent on water quantities. Super-stoichiometric water is observed to result in moderation of peak thermal output, while sub-stoichiometric water addition results in increased peak thermal output compared to stoichiometric addition to a system comprising CaO, P₂O₅, KNO₃, and stoichiometric amount of Fe with coal as a secondary fuel source in a kaolinite matrix. Accordingly, addition of water may be used to control the thermal generation profile.

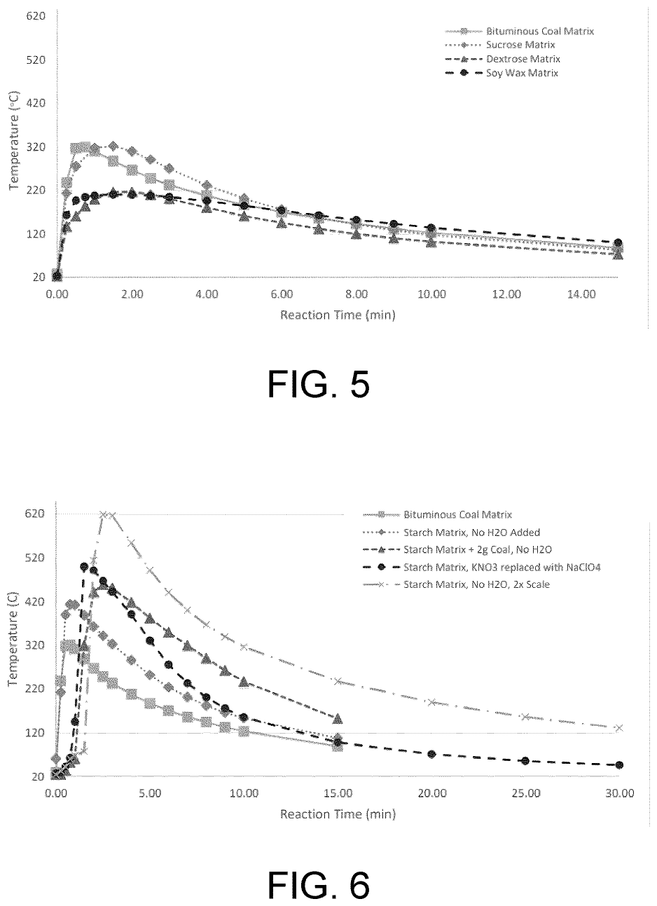

As shown in FIG. 4, variation of the matrix in the thermochemical energy storage system results in different thermal generation profiles. An inert matrix, such as silica sand, results in lower thermal output compared to matrix materials which participate in secondary or tertiary exothermic events, such as bituminous coal or activated carbon. As shown in FIG. 5, different carbon-based matrices result in different thermal generation profiles. Selection of soy wax or dextrose as the matrix results in a lower peak temperature compared to sucrose or bituminous coal. Selection of sucrose or dextrose as the matrix results in a delayed and more gradual exothermic reaction, which indicates more sustained thermal generation as opposed to instantaneous thermal generation.

As shown in FIG. 6, various embodiments of the thermochemical energy storage system result in different thermal generation profiles. Thermal generation is observed even in absence of the addition of liquid water when using starch as the matrix, due to the water naturally contained in commercially available starch. Addition of liquid water is not necessary to initiate thermal generation. If the starch is dried prior to addition to the system, no reaction is observed between the dry reagents. Exothermic reaction is immediately observed upon the addition of water. Even in the absence of liquid water, water naturally contained in starch generates sufficient thermal energy to initiate the secondary fuel sources, such as coal.

While the foregoing is directed to aspects of the present disclosure, other and further aspects of the disclosure can be devised without departing from the basic scope thereof.

1. A thermochemical energy storage system, comprising:
a first reactant;
a second reactant; and
a matrix,
wherein the first reactant and the second reactant react exothermically in the presence of water thereby producing thermochemical energy.

2. The thermochemical energy storage system of claim 1, wherein the first reactant comprises calcium oxide.

3.-4. (canceled)

5. The thermochemical energy storage system of claim 1, wherein the second reactant comprises phosphorus pentoxide.

6.-7. (canceled)

8. The thermochemical energy storage system of claim 1, wherein the matrix comprises between 15% and 35% of the system by mass.

9.-10. (canceled)

11. The thermochemical energy storage system of claim 1, further comprising a third reactant.

12. The thermochemical energy storage system of claim 11, wherein the third reactant comprises one or more of iron, potassium nitrate, and an oxidant.

13.-17. (canceled) found.

18. The thermochemical energy storage system of claim 1, further comprising a secondary fuel source.

19.-21. (canceled)

22. The thermochemical energy storage system of claim 1, wherein the matrix comprises a solid-state source of water.

23. The thermochemical energy storage system of claim 1, further comprising a thermally-insulated reaction vessel adapted for capturing the produced thermochemical energy.

24. The thermochemical energy storage system of claim 1, wherein the first reactant is further defined as having a first activation temperature, the second reactant is further defined as having second activation temperature, and wherein the second activation temperature is higher than the first activation temperature.

25. A method for thermochemical energy storage and release, the method comprising:
providing a first reactant, comprising calcium oxide;
providing a second reactant, comprising phosphorous pentoxide;
providing a matrix;
combining the first reactant, the second reactant, and the matrix in a thermally-insulated reaction vessel;
providing water to initiate a sustained exothermic reaction thereby producing thermochemical energy.

26. The method of claim 25, wherein providing water comprises providing water contained within the matrix.

27. The method of claim 26, wherein the providing water comprises providing water through the addition of hygroscopic solid or mineral hydrates.

28. The method of claim 25, wherein providing water comprises providing water in an amount between 2% to 25% by mass.

29. The method of claim 25, wherein providing a first reactant comprising calcium oxide comprises providing calcium oxide in an amount between 10% to 50% by mass.

30. (canceled)

31. The method of claim 25, wherein providing a second reactant comprising phosphorous pentoxide comprises providing phosphorous pentoxide in an amount between 10% to 55% by mass.

32. (canceled)

33. The method of claim 25, further comprising providing a secondary fuel source.

34. The method of claim 25, further comprising providing a third reactant, wherein the third reactant comprises one or more of iron, potassium nitrate, potassium permanganate, sodium perborate, hydrogen peroxide, potassium perchlorate and potassium chlorate.

35. (canceled)

36. The method of claim 25, wherein the step of providing a first reactant further comprises providing a first reactant having a first activation temperature, wherein the step of providing a second reactant further comprises providing a second reactant having a second activation temperature, and wherein the second activation temperature is higher than the first activation temperature.

37.-38. (canceled)

39. The method of claim 25, further comprising capturing, by the thermally-insulated reaction vessel, the produced thermochemical energy.
